(19) United States
(12) Patent Application Publication
(10) Pub. No.: US 2020/0019960 A1
(43) Pub. Date: Jan. 16, 2020

(54) TECHNOLOGIES FOR DEFINING FUNDS TRANSFER METHODS FOR PAYOUT PROCESSING

(71) Applicant: PayPal, Inc., San Jose, CA (US)

(72) Inventors: William E. Crowley, Vancouver (CA); Blair M. Olynyk, Maple Ridge (CA); Florian Krauthan, Vancouver (CA)

(21) Appl. No.: 16/579,569

(22) Filed: Sep. 23, 2019

Related U.S. Application Data
(63) Continuation of application No. 15/259,240, filed on Sep. 8, 2016.

(51) Int. Cl. G06Q 20/38; G06Q 20/10

(52) U.S. Cl. CPC G06Q 20/385; G06Q 20/10

(57) ABSTRACT

Technologies for defining funds transfer methods for payout processing are described. The funds transfer methods can define payout destinations for a payee on a funds payout computing system. The payout destinations can be in any number of geographic locations and in a variety of currencies and account types. Such funds transfer methods allow a payer to initiate a payout through the funds payout computing system to a payee into an account or other payment vehicle, as defined by the payee. The sensitive financial information used to define the payout destination bypasses the payer and is received by the funds payout computing system when the funds transfer method is defined by the user. The sensitive financial information is linked to a token that is issued by the funds payout computing system and usable by a payer computing system to create the funds transfer method.

### TECHNICAL FIELD

Embodiments of the technologies described herein relate, in general, to the field of electronic payments processing. More particularly, the technologies relate to the field of payout processing by a merchant to a payee.

### BACKGROUND

Transactions, including credit card transactions, are used for a great number of purchases and sales between merchants and cardholders. A normal card transaction can involve a number of parties, including an account holder who possesses a card, a merchant, an acquirer processor, an issuer processor, an issuer financial institution, and a card association network. Millions of such transactions occur daily at merchants using a variety of payment card types, such as credit cards, debit cards, prepaid cards, and so forth. As electronic payment technologies advance, merchants, integrators, and developers continually evolve to meet the demands of the changing payment ecosystem. Such evolutions can be in response to seeking to provide consumers with a relatively frictionless purchase experience in view of the multitude of newly created payment types, changing financial regulations, multi-channel processing, among other variables. However, while technologies associated with payment acceptance have increased and expanded, technologies enabling merchants to perform payouts to payees is largely disjointed, antiquated, and inefficient. Such issues are compounded for merchants needing to provide payouts to payees located in a number of different countries and/or currencies, as banking standards and electronic funds transfer protocols can vary greatly country to country. As such, merchants wishing to easily, quickly, transparently, and cost effectively send payments to payees such as independent contractors, drivers, hosts, and software developers, have limited options.

### SUMMARY

In an embodiment, the present disclosure is directed, in part, to a method for defining a funds transfer method for funds payout processing. The method comprises receiving, by a funds payout computing system from a user device executing a client application hosted by a payer computing system, a funds transfer method initiation request from a user, wherein the funds transfer method is to define a user payout destination usable by the payer computing system. The method further comprises providing, by the funds payout computing system to the user device, a graphical user interface for receiving information from the user to define the funds transfer method. The method further comprises receiving, by the funds payout computing system from the user device, a transfer method definition, wherein the transfer method definition comprises personally identifiable information of the user associated with the user payout destination, and wherein the personally identifiable information is not received by the payer computing system. The method further comprises defining, by the funds payout computing system, a temporary unique identifier linked to the transfer method definition. The method further comprises transmitting, by the funds payout computing system to the user device, the temporary unique identifier. The method further comprises, subsequent to the user device receiving the temporary unique identifier, receiving from the payer computing system a request to create a transfer method for the user on the payout computing system, wherein the request to create a transfer method comprises the temporary unique identifier. The method further comprises, based on the received temporary unique identifier, creating, by the funds payout computing system, a funds transfer method usable by the payer computing system to transfer funds to the user payout destination and associating the funds transfer method with a transfer method token. The method further comprises transmitting, by the funds payout computing system, the transfer method token to the payer computing system.

In another embodiment, the present disclosure is directed, in part, to a funds payout computing system for defining a funds transfer method for funds payout processing, the funds payout computing system comprising logic stored in memory. When the logic is executed by a processor of the funds payout computing system, it causes the funds payout computing system to receive, from a user device executing a client application hosted by a payer computing system, a funds transfer method initiation request from a user, wherein the funds transfer method is to define a user payout destination usable by the payer computing system, and provide to the user device a graphical user interface for receiving information from the user to define the funds transfer method. The logic further causes the processor to receive from the user device a transfer method definition, wherein the transfer method definition comprises personally identifiable information of the user associated with the user payout destination, and wherein the personally identifiable information is not received by the payer computing system. The logic further causes the processor to define a temporary unique identifier linked to the transfer method definition and transmit to the user device the temporary unique identifier. The logic further causes the processor to receive from the payer computing system a request to create a transfer method for the user on the payout computing system, wherein the request to create a transfer method comprises the temporary unique identifier, and based on the received temporary unique identifier, creates a funds transfer method usable by the payer computing system to transfer funds to the user payout destination.

In another embodiment, the present disclosure is directed, in part, to a method for defining a funds transfer method for funds payout processing. The method comprises receiving, by a funds payout computing system from a user device executing a client application hosted by a payer computing system, a funds transfer method initiation request from a user, wherein the client application comprises an embedded Javascript widget associated with the funds payout computing system, and wherein the funds transfer method is to define a user payout destination usable by the payer computing system. The method further comprises providing, by the funds payout computing system to the user device, a graphical user interface comprising a plurality of fields for receiving information from the user to define the first funds transfer method and receiving, by the funds payout computing system from the user device, a transfer method definition based on information provided to the fields by the user, wherein the transfer method definition comprises personally identifiable information of the user associated with the user payout destination, and wherein the personally identifiable information is not accessible by the payer computing system. The method further comprises defining, by the funds payout computing system, a temporary unique identifier linked to the information provided to the fields by the user; and transmitting, by the funds payout computing system to the user device, the temporary unique identifier.

### BRIEF DESCRIPTION OF THE DRAWINGS

It is believed that certain embodiments will be better understood from the following description taken in conjunction with the accompanying drawings, in which like references indicate similar elements and in which:

FIG. 1 is a simplified block diagram of a payment ecosystem depicting payment acceptance and payout processing;

FIG. 2 is a simplified system diagram of one embodiment of a funds payout computing system configured to receive funds transfer method definitions from a user device;

FIG. 3 is a simplified depiction of a graphical user interface of the user device of FIG. 2 in accordance with one non-limiting embodiment;

FIG. 4 is a simplified messaging and processing flow diagram of one embodiment of the system of FIG. 2 for defining a funds transfer method using a funds payout computing system; and

FIG. 5 is a simplified flow diagram of one embodiment of a method for defining a funds payout method.

### DETAILED DESCRIPTION

Various non-limiting embodiments of the present disclosure will now be described to provide an overall understanding of the principles of the structure, function, and use of systems and methods disclosed herein. One or more examples of these non-limiting embodiments are illustrated in the selected examples disclosed and described in detail with reference made to the figures in the accompanying drawings. Those of ordinary skill in the art will understand that systems and methods specifically described herein and illustrated in the accompanying drawings are non-limiting embodiments. The features illustrated or described in connection with one non-limiting embodiment can be combined with the features of other non-limiting embodiments. Such modifications and variations are intended to be included within the scope of the present disclosure.

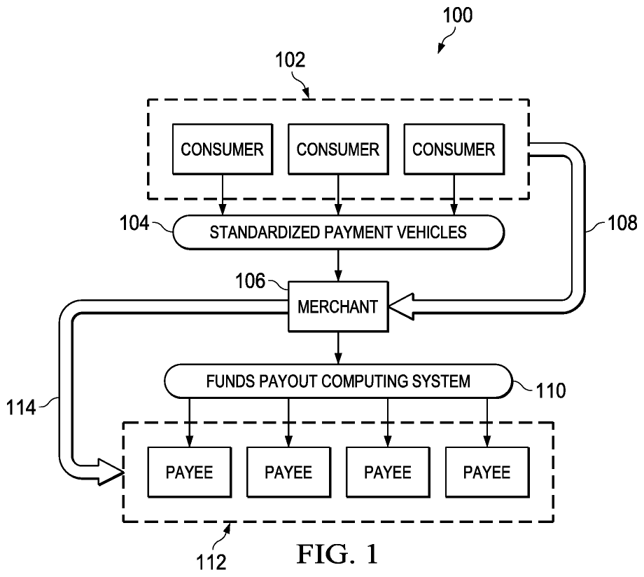

Referring now to FIG. 1, a simplified block diagram of a payment ecosystem 100 depicting payment acceptance and payout processing is shown. Payment acceptance, as shown by arrow 108, generally refers to a merchant 106 accepting transfers of funds from a consumer 102 in exchange for goods or services of the merchant 106. Payment acceptance 108 is a relatively consistent process, as standardized payment vehicles 104 can be used to transfer funds of the consumers 102 to the merchant 106 over well-established payment rails, such as the VISA, MASTERCARD, and AMERICAN EXPRESS payment networks. With the increase in payment innovations, the merchant 106 is able to accept other forms of payment, such as from a mobile wallet of the consumers 102, due to advance in point-of-sale devices and online payment processing. Moreover, due to the cross-border standardization of payment acceptance 108, the merchant 106 can generally accept funds from the consumer 102 irrespective of the consumer's domicile, the type of payment vehicle 104, or the currency of the funds being transferred.

As used herein, payout processing, as shown by arrow 114, generally refers to the merchant 106 electronically sending funds to a payee 112. While payment acceptance 108 is largely well-developed and standardized, conventional approaches for payout processing 114, face technological hurdles and complexities that can make it difficult for the merchant 106 to send payments to payees 112. The type of payee 112 may vary based on the business model of the merchant 106, but example types of payees can include, without limitation, independent contractors (such as participants in multi-level marketing programs), drivers for transportations companies (such as drivers for UBER® or LYFT® transportation companies), hosts for short-term living quarters (such as hosts for AIRBNB® short-term living quarters), sellers of goods through the merchant 106, sellers of the goods of the merchant 106, software developers, and employees, among a wide variety of other types of payees to which the merchant 106 may desire to transfer funds. With payees 112 potentially positioned throughout the world and operating using a multitude of different currencies, sending funds to the payee 112 (i.e., depositing funds in a bank account of the payee) can be inefficient, expensive, and technically complex. For instance, with regard to funds transfer methods involving destination bank accounts, countries around the world use different formats for identifying bank accounts. By way of example, in the United States, a routing number or an ABA number would be used to direct electronic payment to a bank account, while in the United Kingdom a sort code would be used. In the Single Euro Payments Area (SEPA) countries, an International Bank Account Number (MAN) would be used to route payment. While a Swift Code system does generally provide a standardized system for international wire transfers, such transfers are relatively expensive for the merchant 106, are time consuming to process, are routed through a complex network of banks, and still may not provide the merchant 106 with adequate payout options (i.e., for payees 112 that are unbanked).

A funds payout computing system 110 depicted in FIG. 1 and described in more detail below, addresses the deficiencies of the current payout processing methods to allow the merchant 106 to provide payout to the payee 112, largely irrespective of the payee's physical location, currency, and the type of payout destination. As such, the funds payout computing system 110 can allow a payee 112 to identify where he/she wants the funds deposited or sent, and the merchant 106 can transfer funds from its account to the payee 112 through the funds payout computing system 110 thereby removing technical complexities associated with other types of electronic funds transfers. The funds payout computing system 110 can therefore allow the merchant 106 to make global payments into a payout destination of the payee's choice using a single integration, allowing the merchant 106 to provide various types of payments to a payee, such as, without limitation, direct-to-bank payment, local ACH transfers around the world, payments to pre-paid cards (physical and/or virtual), and/or cash/check payments to developing nations where bank accounts may not be prevalent.

As described in more detail below, the funds payout computing system 110 can allow for a payee 112 to provide personally identifiable information (PII) in order to configure the payout destination. The merchant 106, however, will beneficially not have access, store, or otherwise be exposed to the PII, thereby potentially reducing compliance concerns for the merchant 106 as well as reducing the complexities of the client application associated with the merchant 106.

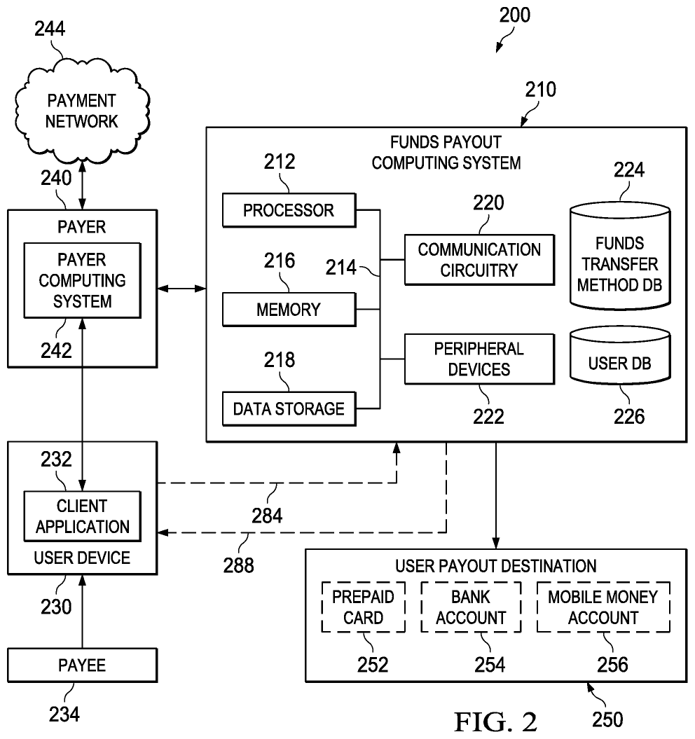

Referring now to FIG. 2, a simplified system diagram 200 of at least one embodiment of a funds payout computing system 210 configured to receive funds transfer method definitions from a user device 230 is depicted. It should be appreciated that although the system diagram 200 includes a single user device 230 and a single payer computing system 242 in the illustrative embodiment, any number of user devices 230 and payer computing systems 242 can be used. A payer 240, as shown in FIG. 2, can be any type of merchant or other type of entity that desires to electrically payout funds to one or more payee 234. In some embodiments, the payer 240 can be associated with a payment network 244 so that it can accept payments (i.e., similar the payment acceptance 108 described above with regard to FIG. 1). The payer 240 can be associated with the payer computing system 242, which generally hosts a client application 232 of the payer 240 that is accessible to the payee 234 through the user device 230. The client application 232 can generally allow the payee 234 to configure a profile or account and/or otherwise expose functionalities of the payer 240 to the payee 234. As is to be appreciated, the client application 232 can be a browser-based application, an application that is downloaded to the user device 230, or a cloud-based application, among a variety of other application types. The client application 232 can be integrated to the funds payout computing system 210, such as through an application programing interface (API), or other data transfer technique. The client application 232 can be developed by, for instance, an agent of the payer 240.

The client application 232 can be configured to utilize one or more services or data provided by the funds payout computing system 210. The client application 232 can be configured to execute on the user device 230 and interact with the payer computing system 242 and the funds payout computing system 210 to provide various services and/or data to the payer 240 and the payee 234. To facilitate access to the provided services and data, the funds payout computing system 210 can be configured to expose one or more APIs (not shown). As such, the payer computing system 242 can be configured to initiate one or more API calls to the exposed APIs. The API calls can be transmitted to the funds payout computing system 210 via one or more web services and protocols (e.g., HTTP, HTTPS, JSON, XML, REST, SOAP, etc.). In embodiments wherein the API calls are transmitted via HTTP messages, or messages having similar protocols, message level encryption can be employed to implement a secure system.

The payee 234 can interact with the payer computing system 242 through the client application 232. During such interaction, the payee 234 can set up a user account with the payer 240, make a payee profile, and so forth. In accordance with the present disclosure, the payee 234 can interact with the client application 232 to securely identify one or more user payout destinations 250. Such user payout destinations 250 are locations to which the payee 234 wants the payer 240 to send funds during payout processing (i.e., similar the payout processing 114 described above with regard to FIG. 1). Generally, when the payee 234 is interacting with the client application 232, information gathered from the payee 234 is provided to the payer computing system 242. However, the funds payout computing system 210 described herein further allows for certain sensitive information to bypass the payer computing system 242 and be submitted to the funds payout computing system 210. In exchange, a temporary unique identifier, which can be a single-use, limited-life token, for example,can be received by the client application 232 from the funds payout computing system 210. This temporary unique identifier can subsequently be passed back to the funds payout computing system 210 by the payer computing system 242 in a subsequent API call or other type of messaging to setup a transfer method for the payee 234 on the funds payout computing system 210. The sensitive information can include banking and financial information related to the payee 234, such as an account number, a routing number, a card number, and so forth. As illustrated in FIG. 2, the sensitive information can identify a prepaid card 252, a bank account 254, a mobile money account 256 of the payee 234, among a wide variety of other types of user payout destinations 250. In return for submitting the temporary unique identifier in the API call to setup a transfer method for the payee 234 on the funds payout computing system 210, the payer computing system 242 can receive from the funds payout computing system 210 a long-life transfer method token. This transfer method token can be stored and then used by payer computing system 242 when submitting API calls to the funds payout computing system 210 to generate a payment to the payee 234 to the payout destination 250.

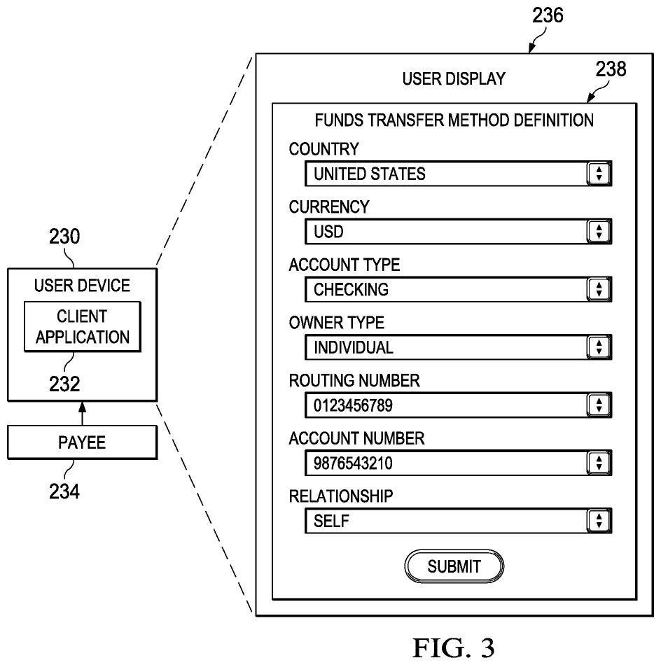

FIG. 3 is a simplified depiction of a graphical user interface of the user device 230 during an example interaction with the payee 234. The graphical user interface is shown as a funds transfer method definition form 238 that is presented on a user display 236 of the user device 230. Referring to FIGS. 2-3, the funds transfer method definition form 238 can be generated by a Javascript widget embedded in the client application 232. The Javascript widget can be executed when the payee 234 is to provide sensitive information, such as to set up one or more payout destinations 250. The Javascript widget can call to the funds payout computing system 210 and then display the funds transfer method definition form 238 on the user device 230 (i.e., in a browser, in an application, or other type of presentment). The funds transfer method definition form 238 can comprise any number of fields as may be required based on the payout destination identified by the payee 234. For instance, the fields of the funds transfer method definition form 238 can be dynamically displayed based on selections of the payee 234, including the language in which the field identifiers are presented. In the illustrated embodiment, sensitive information related to a US checking account is shown to include a routing number and an account number. If a payee 234 indicates that the payout destination is in the UK, for instance, a different grouping of fields is presented in order to gather the necessary information. As is to be appreciated, in order to accommodate payout processing to a number of different geographic locations, the funds payout computing system 210 and the funds transfer method definition form 238 can support a number of different currencies, languages, and account types. The payee 234 can be presented with the funds transfer method definition form 238 in-line with the client application 232. In some cases, the funds transfer method definition form 238 can be rendered in the same style or format as other parts of the client application 232. In order to provide added usability, the funds transfer method definition form 238 can validate the field entries in real-time or substantially real-time in order to ensure that the payee 234 is providing the proper type of information in the proper format based on the identified payout destination 250.

As indicated by communication 284 in FIG. 2, the information provided by the payee 234 to the funds transfer method definition form 238 can be submitted to the funds payout computing system 210 such that the information is not received, stored, by or otherwise exposed to the payer computing system 242. As such, this approach allows sensitive information (i.e., personally identifiable information) to be electronically submitted by a payee 234 to define a payout destination, while limiting access to that sensitive information. Limiting the access can beneficially alleviate various compliance requirements of the payer 240 while also reducing the risk of the information being used for purposes beyond the intentions of the payee 234. Upon receiving the communication 284 with the information submitted by the payee 234, the funds payout computing system 210 can generate a temporary unique identifier that is linked by the funds payout computing system 210 to the sensitive information that was submitted in the funds transfer method definition form 238 by the payee 234. The temporary unique identifier can be returned to the user device 230, as indicated by communication 288 in FIG. 2. The temporary unique identifier created by the funds payout computing system 210 can be for a one-time use, with a limited lifespan (i.e., only valid for a 10 minutes). This temporary unique identifier can then be provided to the payer computing system 242 so that it can be incorporated into a subsequent API call to the funds payout computing system 210 to define the transfer method for the payee 234 on the funds payout computing system 210. Upon receiving the temporary unique identifier in the API call from the payer computing system 242, the funds payout computing system 210 can locate the linked information that was submitted in the funds transfer method definition form 238, which can include personally identifiable information, and then set up the funds transfer method for the payee 234. As shown in FIG. 2, the funds transfer method can be stored in a funds transfer method database 224 and be tied to the payee in a user database 226. Once the transfer method is created by the funds payout computing system 210 based on the sensitive information that was linked to the temporary unique identifier, a transfer method token can then be generated by the funds payout computing system 210 and provided to the payer computing system 242 for storage and subsequent use. As such, when the payer 240 desires to provide payee 234 with a payout, the payer computing system 242 can subsequently pass the transfer method token in appropriate messaging (i.e., a create payment API call) to the funds payout computing system 210 to cause the payout to be processed.

The funds payout computing system 210 can be embodied as a computing device or server capable of processing, communicating, storing, maintaining, and transferring data. For example, the funds payout computing system 210 can be embodied as a server, a mainframe, a desktop computer, a laptop computer, a mobile computing device, a custom chip, an embedded processing device, or other computing device and/or suitable programmable device. In some embodiments, the funds payout computing system 210 can be embodied as a computing device integrated with other systems or subsystems. In the illustrative embodiment of FIG. 2, the funds payout computing system 210 includes a processor 212, a system bus 214, a memory 216, a data storage 218, communication circuitry 220, and one or more peripheral devices 222. Of course, the funds payout computing system 210 can include other or additional components, such as those commonly found in a server and/or computer (e.g., various input/output devices), in other embodiments. Additionally, in some embodiments, one or more of the illustrative components can be incorporated in, or otherwise form a portion of, another component. For example, the memory 216, or portions thereof, can be incorporated in the processor 212 in some embodiments. Furthermore, it should be appreciated that the funds payout computing system 210 can include other components, sub-components, and devices commonly found in a computer and/or computing device, which are not illustrated in FIG. 2 for clarity of the description.

The processor 212 can be embodied as any type of processor capable of performing the functions described herein. For example, the processor 212 can be embodied as a single or multi-core processor, a digital signal processor, microcontroller, a general purpose central processing unit (CPU), a reduced instruction set computer (RISC) processor, a processor having a pipeline, a complex instruction set computer (CISC) processor, an application specific integrated circuit (ASIC), a programmable logic device (PLD), a field programmable gate array (FPGA), or other processor or processing/controlling circuit or controller.

In various configurations, the funds payout computing system 210 includes a system bus 214 for interconnecting the various components of the funds payout computing system 210. The system bus 214 can be embodied as, or otherwise include, memory controller hubs, input/output control hubs, firmware devices, communication links (e.g., point-to-point links, bus links, wires, cables, light guides, printed circuit board traces, etc.) and/or other components and subsystems to facilitate the input/output operations with the processor 212, the memory 216, and other components of the funds payout computing system 210. In some embodiments, the funds payout computing system 210 can be integrated into one or more chips such as a programmable logic device or an application specific integrated circuit (ASIC). In such embodiments, the system bus 214 can form a portion of a system-on-a-chip (SoC) and be incorporated, along with the processor 212, the memory 216, and other components of the funds payout computing system 210, on a single integrated circuit chip.

The memory 216 can be embodied as any type of volatile or non-volatile memory or data storage capable of performing the functions described herein. For example, the memory 216 can be embodied as read only memory (ROM), random access memory (RAM), cache memory associated with the processor 212, or other memories such as dynamic RAM (DRAM), static RAM (SRAM), programmable ROM (PROM), electrically erasable PROM (EEPROM), flash memory, a removable memory card or disk, a solid state drive, and so forth. In operation, the memory 216 can store various data and software used during operation of the funds payout computing system 210 such as operating systems, applications, programs, libraries, and drivers.

The data storage 218 can be embodied as any type of device or devices configured for short-term or long-term storage of data such as, for example, memory devices and circuits, memory cards, hard disk drives, solid-state drives, or other data storage devices. For example, in some embodiments, the data storage 218 includes storage media such as a storage device that can be configured to have multiple modules, such as magnetic disk drives, floppy drives, tape drives, hard drives, optical drives and media, magneto-optical drives and media, Compact Disc (CD) drives, Compact Disc Read Only Memory (CD-ROM), Compact Disc Recordable (CD-R), Compact Disc Rewriteable (CD-RW), a suitable type of Digital Versatile Disc (DVD) or Blu-Ray disc, and so forth. Storage media such as flash drives, solid state hard drives, redundant array of individual disks (RAID), virtual drives, networked drives and other memory means including storage media on the processor 212 or the memory 216 are also contemplated as storage devices. It should be appreciated that such memory can be internal or external with respect to operation of the disclosed embodiments. It should also be appreciated that certain portions of the processes described herein can be performed using instructions stored on a computer-readable medium or media that direct or otherwise instruct a computer system to perform the process steps. Non-transitory computer-readable media, as used herein, comprises all computer-readable media except for transitory, propagating signals.

The communication circuitry 220 of the funds payout computing system 210 can be embodied as any type of communication circuit, device, interface, or collection thereof, capable of enabling communications between the funds payout computing system 210 and the user device 230, the payer computing system 242, computing devices/networks associated with the user payout destinations 250, and/or any other computing device communicatively coupled thereto. For example, the communication circuitry 220 can be embodied as one or more network interface controllers (NICs), in some embodiments. The communication circuitry 220 can be configured to use any one or more communication technologies (e.g., wireless or wired communications) and associated protocols (e.g., Ethernet, Wi-Fi®, WiMAX, etc.) to effect such communication.

In some embodiments, the funds payout computing system 210, the user device 230, the payer computing system 242, computing devices/networks associated with user payout destinations 250, and/or any other computing devices of the system 200, can communicate with each other over one or more networks (not shown). The network(s) can be embodied as any number of various wired and/or wireless communication networks. For example, the network(s) can be embodied as, or otherwise include, a local area network (LAN), a wide area network (WAN), a cellular network, or a publicly-accessible, global network such as the Internet. Additionally, the network(s) can include any number of additional devices to facilitate communications between the computing devices of the system 200.

Additionally, in some embodiments, the funds payout computing system 210 can further include one or more peripheral devices 222. Such peripheral devices 222 can include any type of peripheral device commonly found in a computing device such as additional data storage, speakers, a hardware keyboard, a keypad, a gesture or graphical input device, a motion input device, a touchscreen interface, one or more displays, an audio unit, a voice recognition unit, a vibratory device, a computer mouse, a peripheral communication device, and any other suitable user interface, input/output device, and/or other peripheral device.

The user device 230 can be embodied as any type of computing device capable of performing the functions described herein. As such, the user device 230 can include devices and structures commonly found in computing devices such as processors, memory devices, communication circuitry, and data storages, which are not shown in FIG. 2 for clarity of the description. For instance, the user device 230 can be a desktop computer, a laptop computer, a mobile computing device, a gaming device, a wearable device, and so forth. The payer computing system 242 can be embodied as any type of computing device capable of performing the functions described herein. As such, the payer computing system 242 can include devices and structures commonly found in computing devices such as processors, memory devices, communication circuitry, and data storages, which are not shown in FIG. 2 for clarity of the description. For instance, the payer computing system 242 can be a server, a mainframe, a custom chip, an embedded processing device, or other computing device and/or suitable programmable device.

In some embodiments, the funds payout computing system 210, the user device 230, and the payer computing system 242 can each establish an environment during operation. Each environment can include various modules, components, sub-components, and devices commonly found in computing devices, which are not illustrated in the figures for clarity of the description. The various modules, components, sub-components, and devices of each environment can be embodied as hardware, firmware, software, or a combination thereof. For example, one or more of the modules, components, sub-components, and devices of each environment can be embodied as a processor and/or a controller configured to provide the functionality described herein.

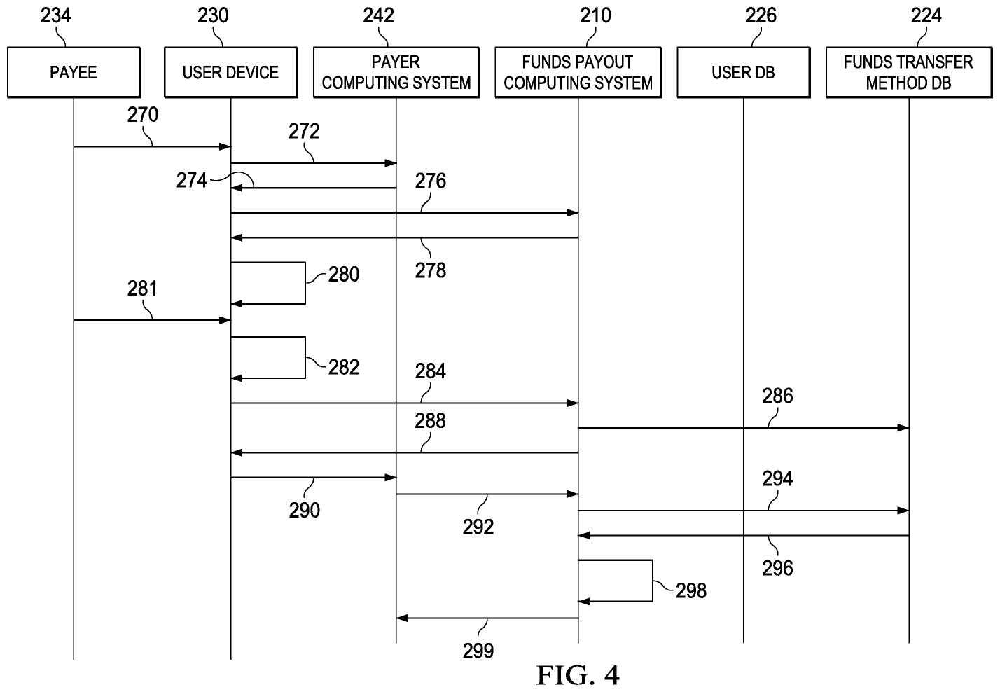

Referring now to FIG. 4, a simplified messaging and processing flow diagram of at least one embodiment of the system of FIG. 2 for defining a funds transfer method using a funds payout computing system 210 is depicted. At flow 270, the payee 234 interacts with the user device 230 to initiate a client application of the payer computing system 242. At flow 272, the user device 230 transmits messaging to the payer computing system 242. The payer computing system 242 returns information to display to the payee 234 at flow 274. The information can relate to setting up a user account, viewing historical data, among other types of interactions. When the payee 234 is set to define a funds transfer method, the user device 230 communicates with the funds payout computing system 210 to download the JavaScript widget to the user device 230, as indicated by flows 276 and 278. At flow 280, the Javascript widget is initialized and a graphical user interface is displayed by the user device 230. The graphical user interface on the user device 230 can be similar to the funds transfer method definition form 238 shown in FIG. 3, for example. At flow 281, the payee 234 populates fields (or otherwise interacts with) the graphical user interface of the user device 230 to enter personally identifiable information to define a desired funds transfer method. As indicated by flow 282, in-line data validation can occur to provide the payee 234 with feedback regarding improper entries. At flow 284, data from the completed funds transfer method definition form 238 (FIG. 3) is submitted to the funds payout computing system 210 for validation. It is noted, that the funds transfer method definition form 238 is not submitted to the payer computing system 242 even though the payee 234 is still engaged with the client application of the payer computing system 242. The funds payout computing system 210 can then create a temporary unique identifier linked to the personally identifiable information that was submitted in the funds transfer method definition form 238. At flow 286, temporary unique identifier and the personally identifiable information can be stored in the funds transfer method database 224 for subsequent use.

At flow 288, the temporary unique identifier is returned to the user device 230 and at flow 290, the temporary unique identifier is passed to the payer computing system 242. In some embodiments, the temporary unique identifier is sent directly to the payer computing system 242 by the funds payout computing system 210. The payer computing system 242 can then initiate the messaging, shown as flow 292, to create a funds transfer method on the funds payout computing system 210. Flow 292 can be an API call which includes an identifier of the payee 234 and the temporary unique identifier. Upon receipt of the temporary unique identifier, the funds payout computing system 210 can retrieve the personally identifiable information previously received from the payee 234 through the funds transfer method definition form 238, as indicate by flow 294, and the returned information (flow 296) can be used to define the transfer method. At flow 298, the funds payout computing system 210 creates a transfer method for the payee 234 usable for future payouts of the payer 240 to the payee 234. In creating the transfer method, a transfer method token associated with that transfer method can be defined by the funds payout computing system 210. At flow 299, the transfer method token is provided to the payer computing system 242 for storage and subsequent use.

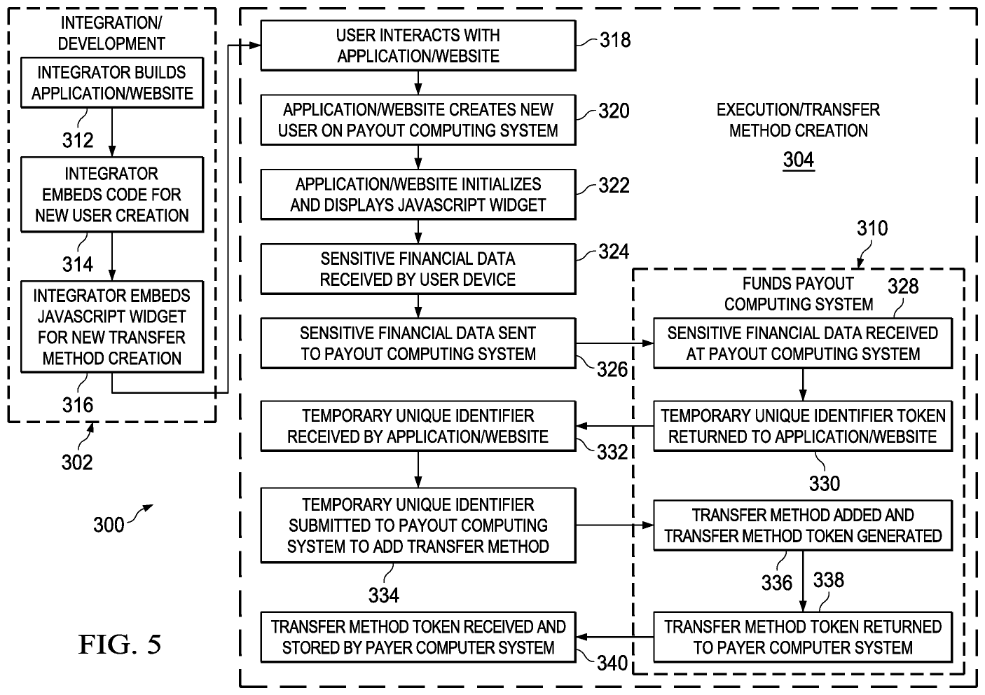

Referring to FIG. 5, a simplified flow diagram 300 of at least one embodiment of a method for defining a funds payout method is shown. The flow diagram 300 begins with an integration/development portion 302. Within the integration/development portion 302, at block 312, an integrator builds an application/website for a payer. The application/website can built with functionality similar to the client application 232 described above. At block 314, the integrator embeds code into the application/website for new user creation on a payout computing system 310. Such code can be an API call that is configured to supply the funds payout computing system 310 with sufficient information to identify a payee and receive a user identifier in return. At block 316, the integrator embeds a Javascript widget into the application/website for new transfer method creation. Such code, when executed, can cause a graphical user interface to be displayed on a user device so that personally identifiable information can be provided to the funds payout computing system 310 while bypassing the computing systems of the payer.

Once the integration/development portion 302 is completed, the application/website is built and an execution/transfer method creation portion 304 can be performed. At block 318, a user interacts with the application/website. The user may be a payee, such as an independent contractor, driver, host, seller, software developer, or employee, among others seeking to receive payouts from the payer associated with the application/website. At block 320, a new user account is created on the funds payout computing system 310 using the code embedded at block 314, such as through an API call. At block 322, the application/website initializes and displays the Javascript widget that was embedded at block 316. As described above, a funds transfer method definition form can be caused to be rendered on a user device of the user that as fields to receive sensitive financial data. At block 324, the sensitive financial data is received from the user and at block 326, the sensitive financial data is sent to the funds payout computing system 310. The sensitive financial data is not received by or sent through a computing system of the payer. At block 328, the sensitive financial data is received at the funds payout computing system 310 and at block 330, a temporary unique identifier is returned to the application/website.

At block 332, the temporary unique identifier is received by the application/website. At block 334, the temporary unique identifier is submitted by the payer computing system to the funds payout computing system 310 to create a transfer method for the user created at block 320 based on the sensitive financial information received at block 324. It is noted however, that the payer computing system does not need to directly pass the sensitive financial information in an API call, as the temporary unique identifier in the API call can be used by the funds payout computing system 310 as a key to access the sensitive financial information previously received from the user. At block 336 the transfer method based on the sensitive financial information is added to a profile of the user created at block 320 and a transfer method token is generated by the funds payout computing system 310. At block 338, the funds payout computing system 310 transfer method token generated at block 336 is returned to the payer computing system for storage and subsequent use. At block 340, the transfer method token is received and stored by the payer computing system. Subsequently, the payer computing system can pass the transfer method token in an API call to the funds payout computing system 310 in order to initiate a payment to the user created at block 320 to the payout destination identified by the sensitive financial data provided in block 324.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed herein should be taken as mandatory for any specific implementation of any of these the apparatuses, devices, systems or methods unless specifically designated as mandatory. In addition, elements illustrated in the figures are not necessarily drawn to scale for simplicity and clarity of illustration. For ease of reading and clarity, certain components, modules, or methods can be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and can be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead can be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics can be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and include a wide variety of electronic information, including executable code; content such as text, video data, and audio data, among others; and various codes or flags. The terms “information,” “data,” and “content” are sometimes used interchangeably when permitted by context. It should be noted that, although for clarity and to aid in understanding, some examples discussed herein might describe specific features or functions as part of a specific component or module, or as occurring at a specific layer of a computing device (for example, a hardware layer, operating system layer, or application layer), those features or functions can be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended that the scope of the invention to be defined by the claims appended hereto.

1-20. (canceled)

21. A method, comprising:
sending, by a transaction processor computer system, a script to a transaction recipient computer system, wherein the script is executable to receive user input for specifying information that enables a transaction to be performed for a particular user;
in response to receiving, from the transaction recipient computer system, particular information inputted by a particular user, the transaction processor computer system generating a unique identifier, wherein the unique identifier is linked to the particular information and is usable to obtain a transaction token that enables a computer system to request that the transaction be performed for the particular user;
sending, by the transaction processor computer system, the unique identifier to the transaction recipient computer system;
in response to receiving the unique identifier from a transaction initiator computer system, the transaction processor computer system sending the transaction token to the transaction initiator computer system; and
after receiving a request from the transaction initiator computer system to perform the transaction for the particular user, the transaction processor computer system performing the transaction based on the particular information and in response to the request including the transaction token.

22. The method of claim 21, wherein the transaction involves transferring funds from an account of a payer associated with the transaction initiator computer system to an account of the particular user.

23. The method of claim 22, wherein the particular information specifies personally identifiable information (PII) that includes routing information that enables the funds to be transferred to the account of the particular user.

24. The method of claim 23, wherein the transaction token enables the transaction initiator computer system to cause the funds to be transferred to the account of the particular user without the PII being exposed to the transaction initiator computer system.

25. The method of claim 22, wherein the script is executable to cause a form that includes a set of fields to be displayed to a user, wherein the set of fields are operable to receive information that enables funds to be transferred from a first account to a second account, and wherein the particular information defines routing information that enables the funds to be transferred from the account of the payer to the account of the particular user.

26. The method of claim 25, wherein the particular information specifies a currency, an account number, and a routing number usable for transferring the funds from the account of the payer to the account of the particular user.

27. The method of claim 25, wherein the set of fields displayed to the user are based on a country value provided by the user.

28. The method of claim 25, wherein the script is executable to determine if values provided for the set of fields are valid before the values are sent to the transaction processor computer system.

29. The method of claim 21, wherein the unique identifier is a single-use token that is valid for a specified interval of time.

30. The method of claim 29, wherein the transaction token is valid for a greater interval of time than the single-use token, and wherein while the transaction token is valid, the transaction token is usable to request that the transaction be performed.

31. A non-transitory computer readable medium having program instructions stored thereon that are executable to cause a transaction processor computer system to perform operations comprising:
receiving, from a transaction recipient computer system, transaction information that enables a transaction to be performed for a particular user;
linking a unique identifier to the transaction information, wherein the unique identifier is usable to obtain a transaction token that enables a computer system to request that the transaction be performed for the particular user;
sending the unique identifier to the transaction recipient computer system;
in response to receiving the unique identifier from a transaction initiator computer system, sending the transaction token to the transaction initiator computer system; and
after receiving a request from the transaction initiator computer system to perform the transaction for the particular user, performing the transaction based on the transaction information and in response to the request including the transaction token.

32. The medium of claim 31, wherein the transaction involves transferring, based on personally identifiable information (PII) specified in the transaction information, funds from an account of a payee associated with the transaction initiator computer system to a payout destination associated with the particular user.

33. The medium of claim 32, wherein the transaction token enables the transaction initiator computer system to cause the transaction to be performed without the PII being exposed to the transaction initiator computer system.

34. The medium of claim 31, wherein the operations further comprise:
sending, to the transaction recipient computer system, a script that is executable within an application hosted by the transaction initiator computer system, wherein the script is executable to receive the transaction information.

35. The medium of claim 31, wherein the unique identifier is usable once to obtain the transaction token and is valid for a specified interval of time that is less than a time for which the transaction token is valid.

36. A method, comprising:
linking, by a transaction processor computer system, a first unique identifier to first routing information received from a first recipient computer system, wherein the first unique identifier is usable to obtain a first token that enables a computer system to request that funds be routed to a first destination associated with a first user;
linking, by the transaction processor computer system, a second unique identifier to second routing information received from a second recipient computer system, wherein the second unique identifier is usable to obtain a second token that enables a computer system to request that funds be routed to a second destination associated with a second user, wherein the second routing information specifies a different routing procedure than the first routing information;
sending, by the transaction processor computer system, the first unique identifier to the first recipient computer system and the second unique identifier to the second recipient computer system;
in response to receiving the first and second unique identifiers from an initiator computer system, the transaction processor computer system providing the first and second tokens to the initiator computer system;
after receiving a first request from the initiator computer system to route first particular funds to the first destination, the transaction processor computer system transferring the first particular funds based on the first routing information and in response to the first request including the first token; and
after receiving a second request from the initiator computer system to route second particular funds to the second destination, the transaction processor computer system transferring the second particular funds based on the second routing information and in response to the second request including the second token.

37. The method of claim 36, wherein the first and second tokens enable the initiator computer system to cause funds to be routed to the first and second destinations, respectively, without the first and second routing information being exposed to the initiator computer system.

38. The method of claim 36, wherein the first routing information specifies a different currency than the second routing information.

39. The method of claim 36, wherein the first routing information specifies a different type of routing number than the second routing information.

40. The method of claim 36, further comprising:
sending, to first recipient computer system, a script executable:
receive the first routing information from the first user; and
validate the first routing information to ensure that the first routing information is in a valid format.
